(19) United States
(12) Patent Application Publication
(10) Pub. No.: US 2019/0229460 A1
(43) Pub. Date: Jul. 25, 2019

(54) PROTECTIVE COVER ELEMENT AND WATERPROOF HOUSING FOR ELECTRICALLY FUNCTIONAL COMPONENTS

(71) Applicant: FRIWO Gerätebau GmbH, Ostbevem (DE)

(72) Inventors: Stefan Suttorp, Nordkirchen (DE); Weihua Jiang, Shenzhen (CN)

(21) Appl. No.: 16/256,699

(22) Filed: Jan. 24, 2019

(30) Foreign Application Priority Data
Jan. 24, 2018 (EP) 18 153 164.1

(51) Int. Cl. H01R 13/52; H02G 15/113; H01R 13/506; H01R 13/523

(52) U.S. Cl. CPC H01R 13/5213; H02G 15/113; H01R 13/523; H01R 13/506; H01R 13/5205

(57) ABSTRACT

A cover element for protecting a lead-through of an electrical cable at a housing of an electronic component. The cover element including a first half shell, a second half shell, a first sealing means, and a second sealing means. The second half shell is attached to the first half shell by means of at least one locking element, so that said cover element encompasses said electrical cable and said lead-through at least partly. The first sealing means is configured to seal an interface between the cover element and the cable. The second sealing means is configured to seal an interface between said cover element and the housing.

### FIELD OF THE INVENTION

The present invention relates to a cover element for protecting a lead-through of an electrical cable at a housing of an electronic component, to a waterproof housing arrangement for an electrical apparatus, to a waterproof power supply unit for supplying a consumer with low voltage, and to a corresponding method of assembling an electrical apparatus.

Power supply units supplying a consumer with a low voltage by transforming the supply voltage into the required low voltage by means of a voltage transformer are nowadays widely spread. It is necessary for certain applications, e.g. for charging outdoor equipment, that the power supply unit can be safely operated in moist environment. Here, the protection class IPx4, or even IPx7 has to be observed.

As is generally known, the so-called IP code (Ingress Protection) relates to the protection against splashing water all-around (IPx4) and the protection against temporary submersion (IPx7) according to the Standard DIN EN 60529 [DIN EN 60529:2014-09 (VDE 0470-1):2014-09 Degrees of protection provided by enclosures (IP Code) (IEC 60529:1989+A1:1999+A2:2013); German version EN 60529:1991+A1:2000+A2:2013. Beuth-Verlag, Berlin].

In order to seal a casing in accordance with protection class IPx7, it is known, on the one hand, to arrange the power input lead, the output lead, and all components of the power supply unit within a casing and to fill this casing completely with an electrically insulating casting resin. An alternative to such a complete filling is the sealing of the casing by means of an ultrasonic welding seam. However, the ultrasonic welding alternative is not as process-reliable as the complete filling because the tightness depends on the quality of the welding seam and can be subject to certain unacceptable fluctuations. Filling the plug-in power supply unit completely, on the other hand, has the disadvantage that the weight and the material expenditure are relatively high and, moreover, that the detection of causes of failure is rendered more difficult due to the fact that all of the components are inseparably enclosed by the casting resin.

Furthermore, it was realized by the inventors of the present application that the encapsulation of all of the components with a casting resin may lead to leakage currents between the electric components, causes problems with electromagnetic interference (EMI), and leads to undesirable acoustic phenomena.

Moreover, the inventors recognized that the most critical area that has to be protected against the intrusion of moisture is the lead-through for the primary sided cable which is to be connected with the mains voltage. This is of course also true for any other kind of cable lead-through.

### SUMMARY OF THE INVENTION

The object underlying the present invention is to provide means for achieving a waterproof housing for an electrical apparatus, a power supply unit and an associated manufacturing method allowing, on the one hand, the observance of a protection class which is suited for the operation in a moist area and, on the other hand, a significant reduction of manufacturing costs and the complexity.

The present invention is based on the idea that the necessary protection against intrusion of moisture at a lead-through of a housing can be achieved by providing an additional protective cover that is sealed against the housing in the one hand and against the cable on the other hand. By forming the cover element from two half shells, the cover element can be attached after all other components have been assembled. Thus, no time consuming resin casting steps are needed. Moreover, the cover element can be made removable, so that the cable may easily be removed and replaced if such maintenance is required.

In particular, according to the present invention, a cover element for protecting a lead-through of an electrical cable at a housing of an electrically functional component is provided, said cover element comprising a first half shell and a second half shell. The second half shell is attached to the first half shell by means of at least one locking element, so that said cover element encompasses said electrical cable and said lead-through at least partly. The cover element further comprises first sealing means for sealing an interface between the cover element and the cable, and second sealing means for sealing an interface between said cover element and the housing.

The cover element may for instance be formed from a plastic material, preferably the same material as the housing. However, it is clear for a person skilled in the art that any other material, also metal, may be used for forming the cover element. Moreover, the two half shells do not necessarily have to be formed from the same material. Although in the following the term “half shell” is used for the two separate parts of the cover element, it has to be noted that the shell do not literally have to cover exactly half of the circumference of the cable each. Also, the first and second half shells do not have to be of the same size. Finally, the cover element may also be constituted of more than two parts, at least one of the half shells being divided in separate portions.

According to an advantageous embodiment of the present invention, said at least one locking element comprises at least one snap hook arranged at said first or second half shell and a corresponding snap fit recess for interacting with the snap hook, the snap fit recess being arranged on the opposing second or first half shell. Such a snap fit connection has the advantage that it can be assembled fast and without requiring additional tools. Moreover, snap fit connections are mechanically stable and exert sufficiently strong forces in order to safely join the first and second half shells.

In order to allow for the cover element being removable, said snap fit recess comprises a cut free bridge which interacts with the snap hook being formed by an outwardly oriented cantilever snap hook. Due to this arrangement, the snap hook is accessible from the outside, so that the snap fit connection may be released and the cover element can be disassembled for removing the cable. This is advantageous for maintenance purposes. In particular, the locking element may be manually releasable, so that no additional tools needed for removing the cable. In this case even the consumer can perform the cable exchange and can purchase a new cable as a spare part.

According to a further advantageous embodiment, the cover element comprises third sealing means for sealing a contact interface between said first and said second half shell. This has the advantage that no moisture can intrude into the cover element. Advantageously, at least one of the first to third sealing means comprises an elastic plastic material. For instance, a resilient silicone material can be used. According to the present invention, the sealing means are fabricated as separate silicone grommets. However, it is clear for a person skilled in the art that the resilient sealing means may also be integrally formed at the cover element a means of a multistage casting process.

According to an advantageous embodiment of the present invention, the cover element comprises a collar that extends inwardly toward a central longitudinal axis of the cover element, and is formed to engage with a mating groove at the housing for fixing the cover at the housing. Thereby, the cover element grips tightly to the housing and is therefore firmly attached thereto. Moreover, by securing the cover element to an outside part of the housing, the cover element may be attached after the housing is completely assembled. Furthermore, the housing is not impaired by removing the cover element and the cable.

Advantageously, said cover element comprises retention means for providing a traction relief for the electrical cable. Thus, the cable is not mechanically interlocked with the housing itself but is secured housing via the cover element. By securing the cable only to the cover element, the cable cannot be pulled out and disconnected from the electrically functional component as long as the cover element is in place, but may easily be removed after the cover element has been disengaged.

In order to avoid that the cable is bent over sharp edges and is kinked or damaged, the cover element comprises a funnel shaped cable inlet, and wherein said first sealing means is arranged at an inner end of the funnel.

The present invention further provides a waterproof housing arrangement for an electrical apparatus, the housing arrangement comprising a housing with at least one lead-through and a cover element.

According to an advantageous embodiment, the lead-trough is surrounded by an outwardly oriented flange forming said groove for engaging with said collar. In this manner, the flange and the collar interlock firmly with each other, thereby avoiding that the cable may be pulled out unintentionally. Moreover, the second sealing means may be arranged at a contact area between said outwardly oriented flange and said collar. This effectively prevents moisture from entering at the interface between the housing and the cover element.

Advantageously, the first sealing means is in sealing contact with a cable jacket, exerting radial forces on the cable jacket, and the first sealing means is further in sealing contact with a circumferential protrusion arranged at the cable for exerting axial pressure on the protrusion. This intimate contact improves the sealing between the cover element and the cable, so that no moisture can enter into the cover element at the interface between the cover element and the cable.

The cover element according to the present invention may efficiently be used with a power supply unit for supplying a consumer with low voltage, comprising a housing arrangement according to the present invention, an electric converter circuit for converting mains voltage from a power source into a lower output voltage, and the electrical cable, wherein the electrical cable is connectable to said power source and/or wherein said electrical cable is connected to said electronic converter circuit via a releasable plug connection.

The present invention further relates to a method of assembling an electrical apparatus, comprising the following steps:

providing a case body (also referred to as a housing) with an electrically functional component accommodated therein, the case body having at least one lead-through for leading an electrical cable that is connected to the electrically functional component to the outside of the case body, inserting said cable into the lead-through in an insertion direction along a longitudinal axis of said case body, and electrically connecting the electrical cable to said electrically functional component, attaching a cover element according to the present invention, wherein the first half shell and the second half shell are assembled in an assembly direction perpendicular to said longitudinal axis and jointed to encompass said electrical cable.

By mounting the first and second half shells in an assembly direction which is perpendicular to the longitudinal axis of the case body, a secure mechanical mounting can be achieved after the assembly of the electrically functional components is finished. The cable is secured at the housing only via the cover element, so that by removing the cover element also the cable becomes removable.

### BRIEF DESCRIPTION OF THE DRAWINGS

The accompanying drawings are incorporated into the specification and form a part of the specification to illustrate several embodiments of the present invention. These drawings, together with the description serve to explain the principles of the invention. The drawings are merely for the purpose of illustrating the preferred and alternative examples of how the invention can be made and used, and are not to be construed as limiting the invention to only the illustrated and described embodiments. Furthermore, several aspects of the embodiments may form—individually or in different combinations—solutions according to the present invention. The following described embodiments thus can be considered either alone or in an arbitrary combination thereof. Further features and advantages will become apparent from the following more particular description of the various embodiments of the invention, as illustrated in the accompanying drawings, in which like references refer to like elements, and wherein:

FIG. 1 is a perspective view of a lead-through at the housing of a power supply unit;

FIG. 2 is a perspective partly exploded view of the housing of FIG. 1 with a water tight cover element according to the present invention;

FIG. 3 is a perspective view of a first half shell of the water tight cover element according to the present invention;

FIG. 4 is a perspective view of a second half shell of the water tight cover element according to the present invention;

FIG. 5 is a sectional view of the power supply unit of FIG. 1;

FIG. 6 is a detail of FIG. 5;

FIG. 7 is another detail of FIG. 5;

FIG. 8 is another perspective view of the housing of FIG. 1 with a water tight cover element according to the present invention;

FIG. 9 is a perspective view of a top element of a housing for a power supply;

FIG. 10 is a perspective view of a bottom element of the housing for a power supply;

FIG. 11 is a sectional view of the bottom element shown in FIG. 10;

FIG. 12 is a further sectional view of the bottom element shown in FIG. 10;

FIG. 13 is a top view of the bottom element shown in FIG. 10;

FIG. 14 is a side view of the bottom element shown in FIG. 10;

FIG. 15 is another side view of the bottom element shown in FIG. 10;

FIG. 16 is another side view of the bottom element shown in FIG. 10;

FIG. 17 is a bottom view of the bottom element shown in FIG. 10;

FIG. 18 is a sectional view of the top element shown in FIG. 9;

FIG. 19 is a further sectional view of the top element shown in FIG. 9;

FIG. 20 is a top view of the top element shown in FIG. 9;

FIG. 21 is a side view of the top element shown in FIG. 9;

FIG. 22 is another side view of the top element shown in FIG. 9;

FIG. 23 is another side view of the top element shown in FIG. 9;

FIG. 24 is a bottom view of the top element shown in FIG. 9;

FIG. 25 is a first view of the lower half shell of the cover element shown in FIG. 2;

FIG. 26 is a second view of the lower half shell of the cover element shown in FIG. 2;

FIG. 27 is a third view of the lower half shell of the cover element shown in FIG. 2;

FIG. 28 is a first view of the upper half shell of the cover element shown in FIG. 2;

FIG. 29 is a second view of the upper half shell of the cover element shown in FIG. 2;

FIG. 30 is a third view of the upper half shell of the cover element shown in FIG. 2;

FIG. 31 is a perspective view of a sealing element arranged at the first half shell of the water tight cover element;

FIG. 32 is a perspective view of sealing elements arranged at the second half shell of the water tight cover element.

### DETAILED DESCRIPTION

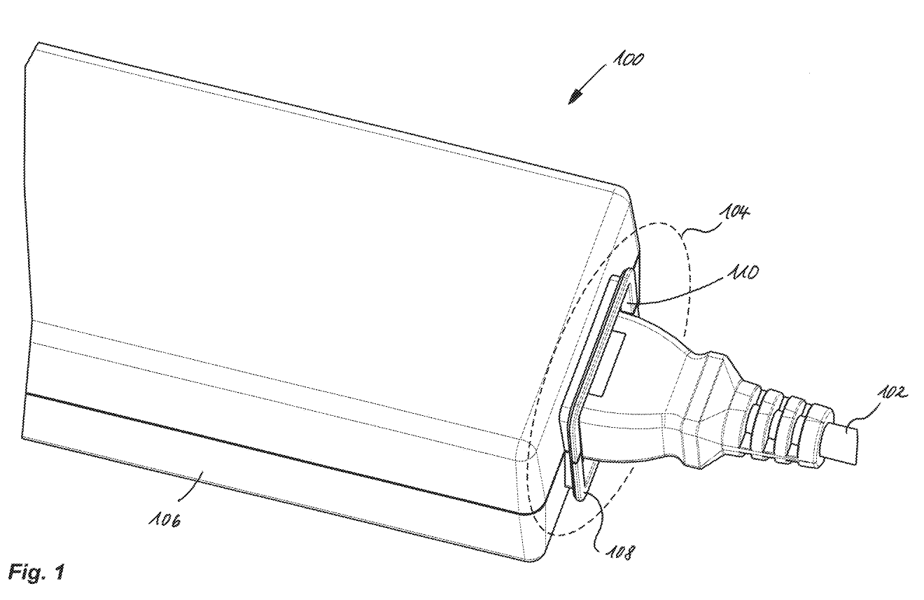

The present invention will now be explained in more detail with reference to the Figures and firstly referring to FIG. 1.

FIG. 1 shows a perspective view of a housing 100 and an electrical cable 102 which is passed through a lead-through 104 to the inside of the housing 100 in order to be connected with electrically functional components (not shown in the figures) arranged inside the housing 100. According to the present invention, the lead-through 104 is formed by an essentially rectangular opening 110 in the case body 106 of the housing 100.

The lead-through 104 comprises a flange 108 which surrounds the complete circumference of the opening 110. As shown in FIG. 1, the housing assembly with the cable connected to the electrically functional components inside the housing would not be sufficiently sealed against the intrusion of moisture at the interface between the housing 100 and the cable 102.

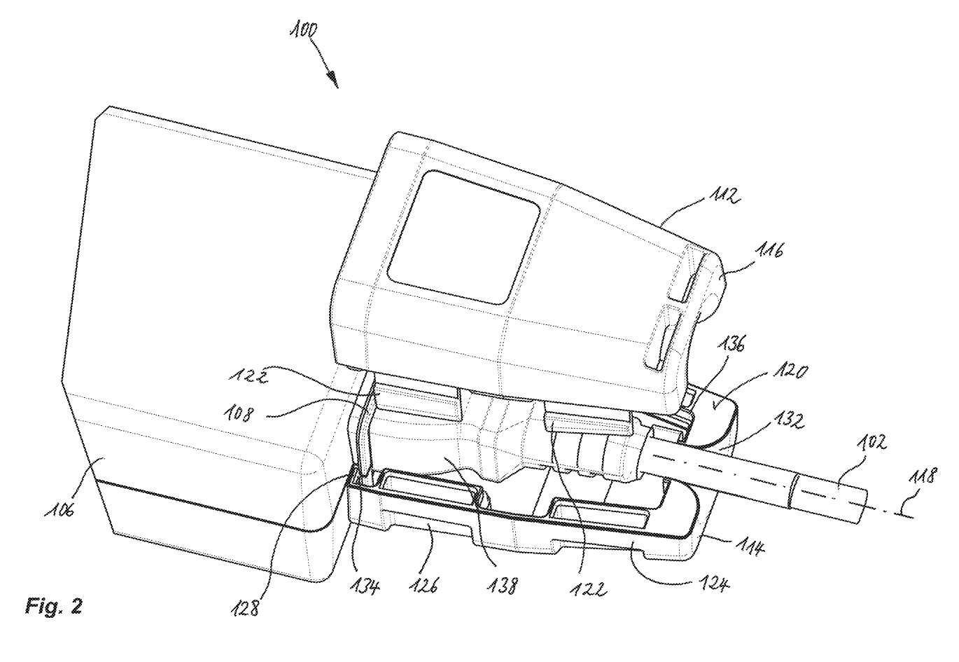

In order to solve this problem, the present invention proposes using a cover element 112 which is shown in detail in FIG. 2.

The cover element 112 comprises a first half shell 114 (which may also be referred to as a base) and a second half shell 116 (which may also be referred to as a cover). The first half shell 114 and the second half shell 116 are joined together in a joining region 120 which is oriented along the longitudinal axis 118 of the cable and the housing 100.

The second half shell comprises snap hooks 122 which lock the second half shell 116 at cut free bridges 124 which are provided at the first half shell 114. In the shown embodiment, four snap hooks 122 and four corresponding bridges 124 which form snap fit recesses 126 for interacting with the snap hooks are provided. However, it is clear for a person skilled in the art that any desired number of such locking elements can be provided. Advantageously, the snap fit recesses 126 are accessible from the outside, so that the snap fit hooks 122 can be pressed inwardly manually in order to loosen the connection between the first half shell 114 and the second half shell 116.

Moreover, as will be more apparent from the following drawings, the cover element 112 comprises a collar 128 which grips behind the flange 108 provided at the housing 100 for securing the cover element 112 at the housing 100.

Furthermore, first sealing means 130 are provided at a cable inlet 132 in order to seal the interface between the cable 102 and the inside of the cover element 112. Second sealing means 134 are arranged between the collar 128 and the flange 108 in order to seal the interface between the housing 100 and the cover element 112. Furthermore, third sealing means 136 are provided for sealing the interface between the first half shell 114 and the second half shell 116. Advantageously, all three sealing means are formed by a resilient material, such as silicone rubber. However, any other suitable soft material that is able to perform a watertight closure at the respective interfaces may be used as the sealing means.

According to the embodiment shown in the drawings, the cable 102 is terminated by a plug connector 138 which can be connected to the electrically functional components inside the housing 100. As will be more apparent from the following drawings, the cover element 112 comprises retention means that interact with the plug connector 138 so that same cannot be drawn out in the direction along the longitudinal axis 118, once the cover element 112 is firmly mounted at the flange 108.

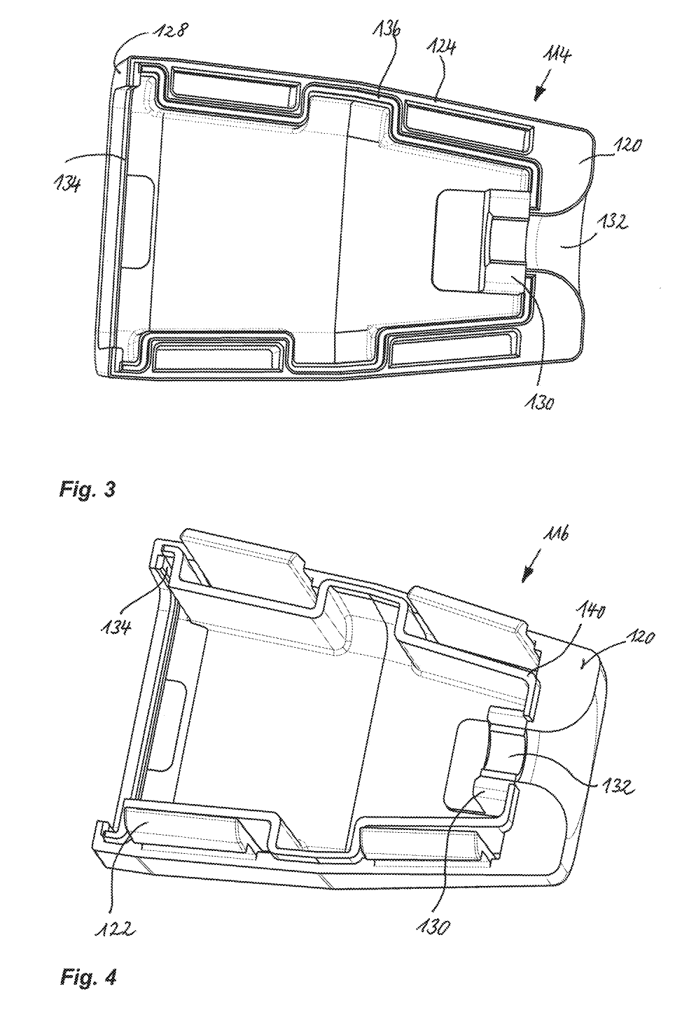

FIG. 3 shows a perspective view of the first half shell 114 as can be seen from this Fig. the cable inlet 132 has a funnel shape with rounded edges in order to avoid damaging and/or kinking the cable 102. Moreover, a silicone seal 130 is arranged at the inner end of the funnel shaped cable inlet 132. An inwardly turned collar 128 is provided for interacting with the groove (also referred to as a slot) formed by the flange 108 at the housing 100 (as shown in FIG. 2). Second sealing means 134 are arranged at the inside of the color 128 in order to be pressed against the flange 108. The sealing means 134 is preferably a resilient silicone gasket.

For sealing the interface between the two adjoining half shells 114, 116 a third silicone gasket is provided which runs along the joining region 120. The second half shell 116 comprises matching protrusions 114 that are pressed onto the third sealing means 136.

Cut free bridges 124 form recesses 126 for interacting with the snap fit hooks 122 (see FIG. 2).

FIG. 4 shows a perspective view of the second half shell 116 of the cover element 112 seen from the inside. As already mentioned above, the second half shell 116 comprises protrusions 114 which are arranged along the joining region 124 compressing the gasket 136. Furthermore, first and second sealing means 130, 134 are arranged at the cable inlet 132 and at the collar 134, respectively.

Four cantilever snap hooks 122 are arranged outside the protrusions 140 and deflectable towards the central axis 118. Thereby, manual access to the snap hooks 122 from the outside is guaranteed, without impairing the watertightness of the cover element 112.

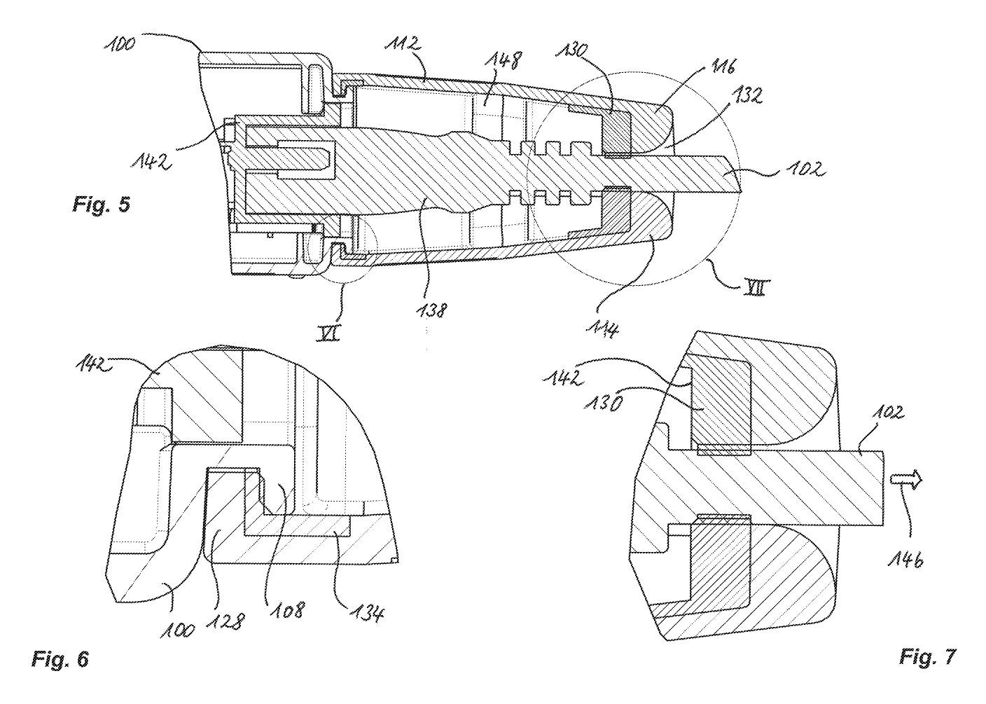

FIGS. 5 to 7 illustrate in a cut view some further details of the cover element 112 and the lead-through 104. As already mentioned above, the cable is terminated by a plug connector 138. As can be seen from FIG. 5, the plug connector 138 is connected to a mating connector 142 which is arranged inside the housing 104 for electrically contacting the electrically functional components inside the housing 100. As can be seen from FIGS. 5 and 6, the collar 128 grips into a groove formed by the flange 108 at the housing 100. At this interface, second sealing means 134 seal the interface between the collar 128 and the flange 108, so that the interface between the cover element 112 and the housing 100 is sealed watertightly. The soft material of the sealing means is interference fitting with the flange and the collar in order to achieve the watertightness.

As already mentioned above, the first sealing means 130 is provided at the inner end of the funnel shaped inlet 132. The first sealing means 130 is formed by two parts: one is arranged at the first half shell 114 and one is arranged at the second half shell 116. As can be seen from FIG. 5 together with the detail shown in FIG. 7, the first sealing means 130 forms a retention shoulder 142 for fixing the cable at corresponding protrusions 144 against being pulled in the direction 146. Furthermore, as can be seen from FIG. 5, the cover element 112 also comprises a retention groove 148 acting as an additional strain relief against pulling forces. In other words, the soft material of the sealing means interacts with the cable jacket in order not only to achieve waterproofness, but also to mechanically fix the cable and to prevent pulling out the cable.

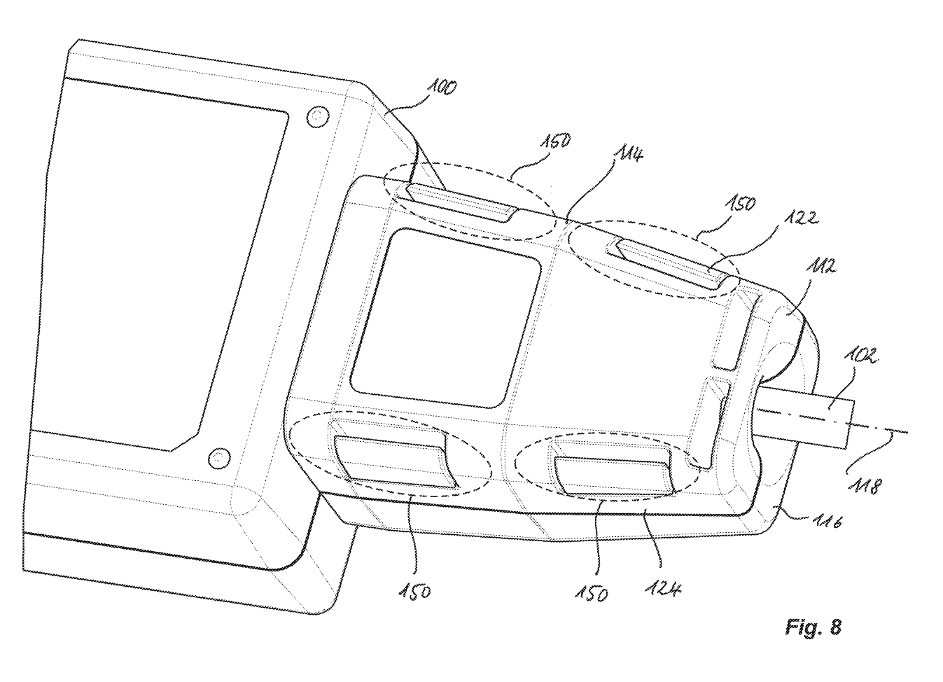

FIG. 8 shows a perspective view of the housing 100 with the mounted cover element 112 from the underside. As can be seen from this Figure, four snap lock connections 150 are formed by the snap fit hooks 122 being engaged with the cut free bridges 124. According to the present invention, each of the snap fit hooks 122 can be deflected towards the central axis 118, thereby loosening the grip against the cut free bridge 124 and allowing the first half shell 114 and the second half shell 116 to be separated from each other and to be removed from the cable 102 and the housing 100.

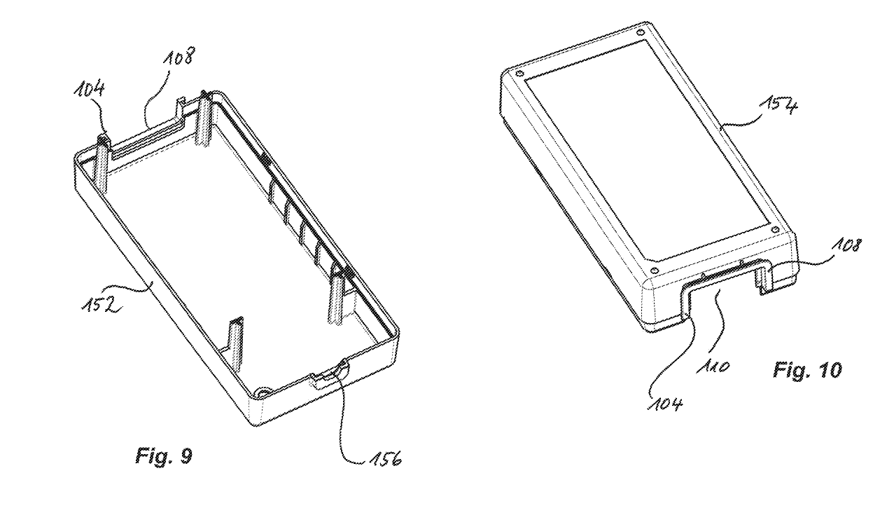

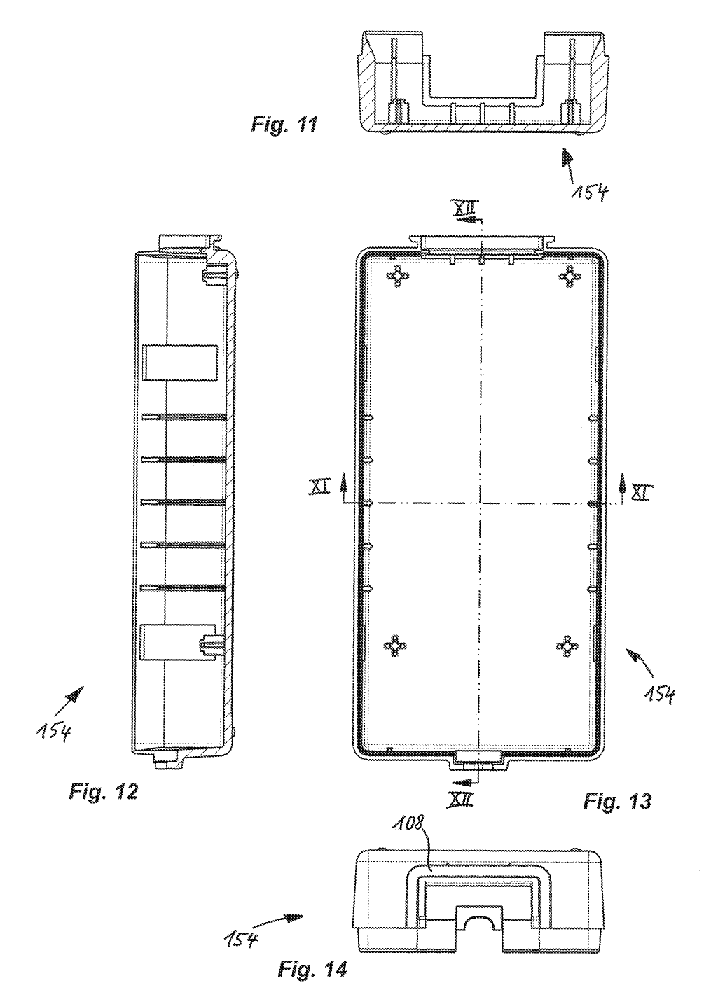

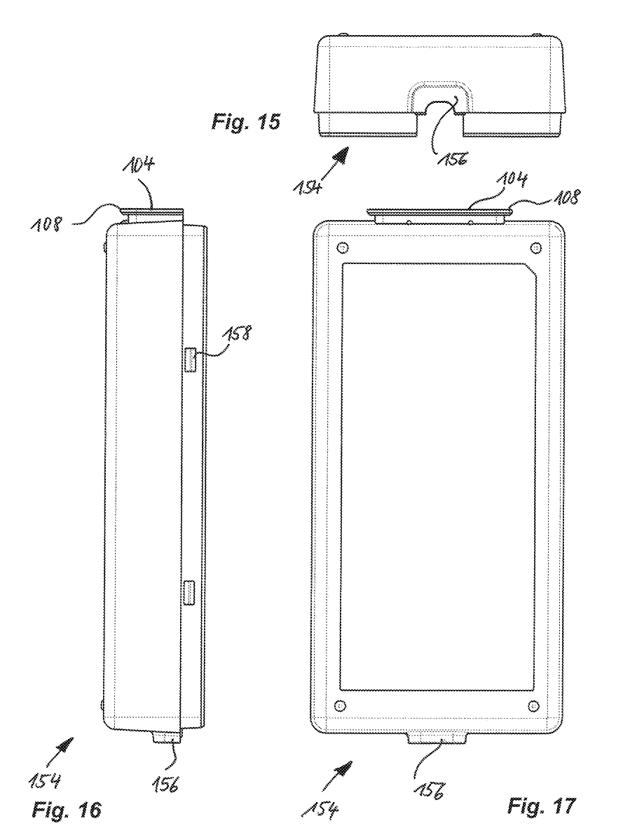

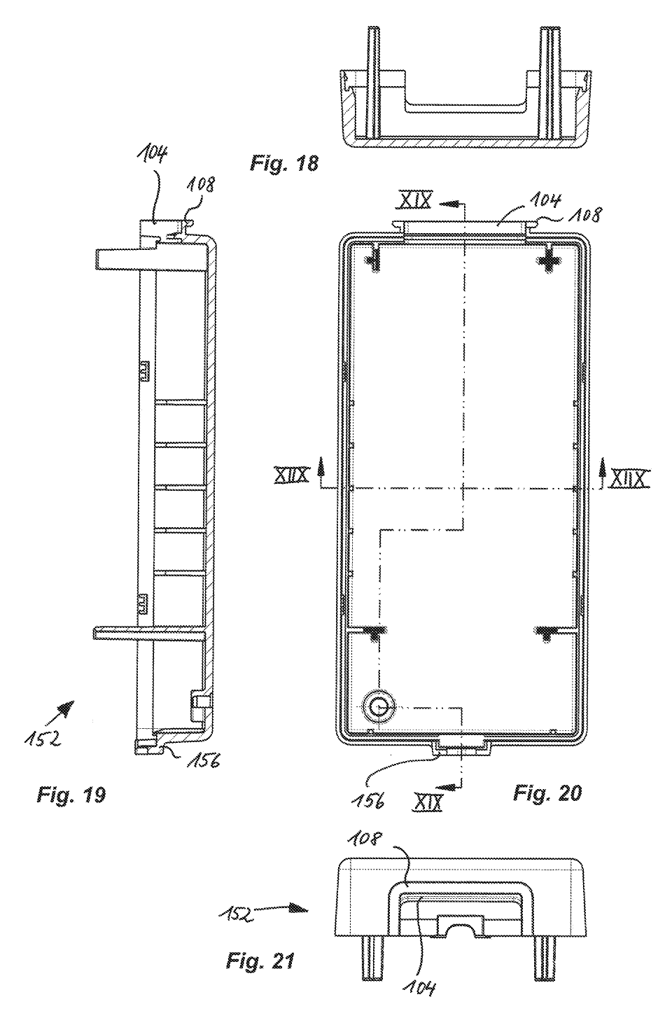

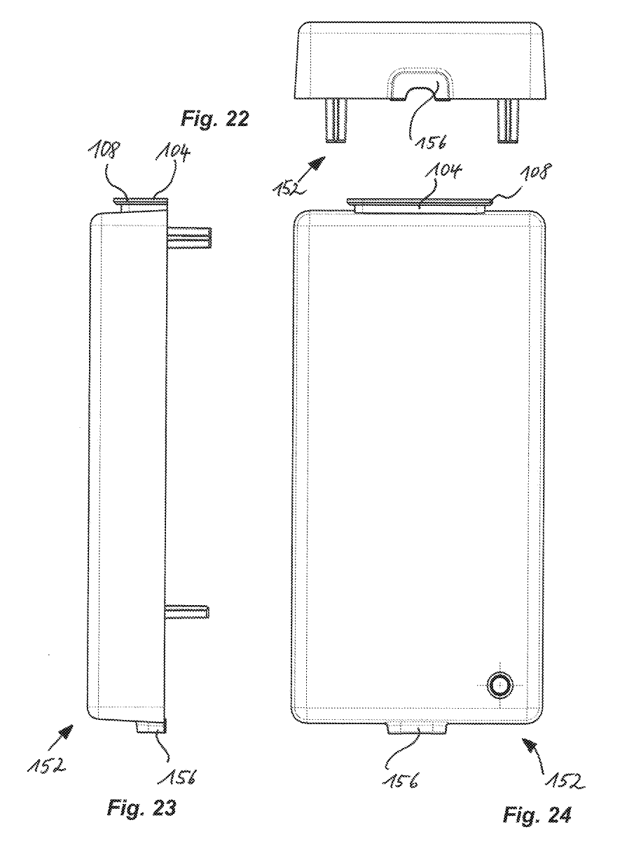

FIGS. 9 and 10 depict a top element 152 and a bottom element 154 of the housing 100, respectively. When being joined together, the top element 152 and the bottom element 154 form an essentially rectangular opening 110 which is surrounded by the flange 108. In order to seal the interface between the top element 152 and the bottom element 154, the two elements are welded together by laser welding. Alternatively, of course also gluing or a snap fit connection similar to the snap hooks 122 can be envisaged. At the side of the housing opposing to the lead through 104, a second lead-through 156 for attaching a low-voltage cable can be provided. As the low-voltage cable (not shown in the figures) is less critical regarding the electrical protection, a simple silicone seal at the inside of the second lead through 156 is sufficient for meeting the protection requirements. FIGS. 11 to 17 show several views of the bottom element 154 of the housing.

As can be seen from FIG. 16, the bottom element 154 comprises snap fit protrusions 158 for interacting with belonging snap fit recesses 160 at the top element 152 (see FIG. 19 below).

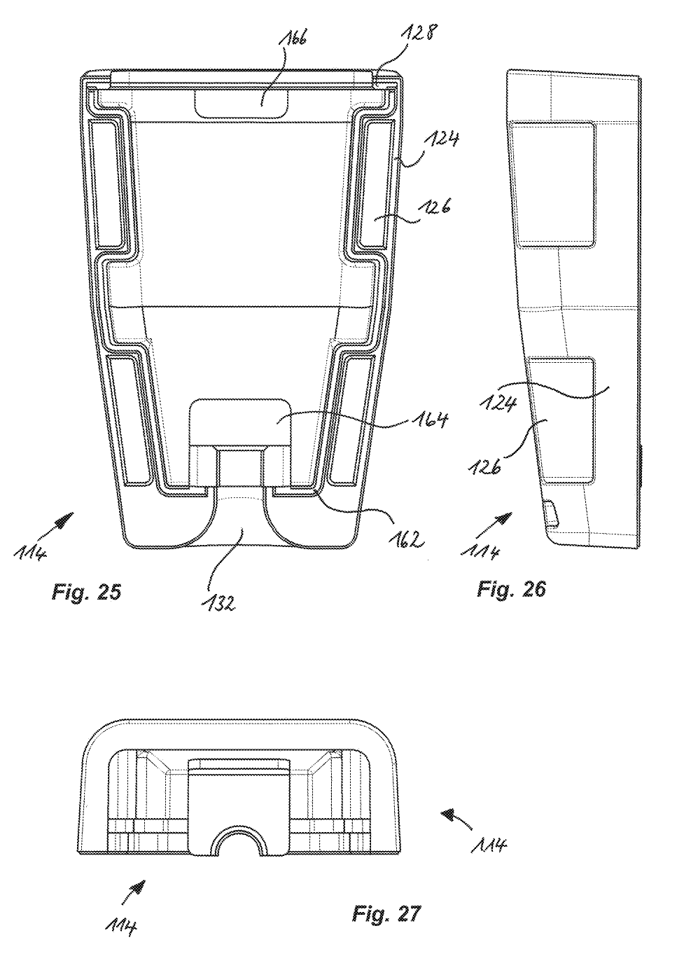

FIGS. 25 to 27 show detailed views of the first half shell 114 of the cover element 112 according to the present invention. According to the present invention, the first half shell 114 comprises a notch 162 for mounting the third sealing means 136. Furthermore, first and second indentations 164, 166 are provided for anchoring the first and second sealing means 130, 134.

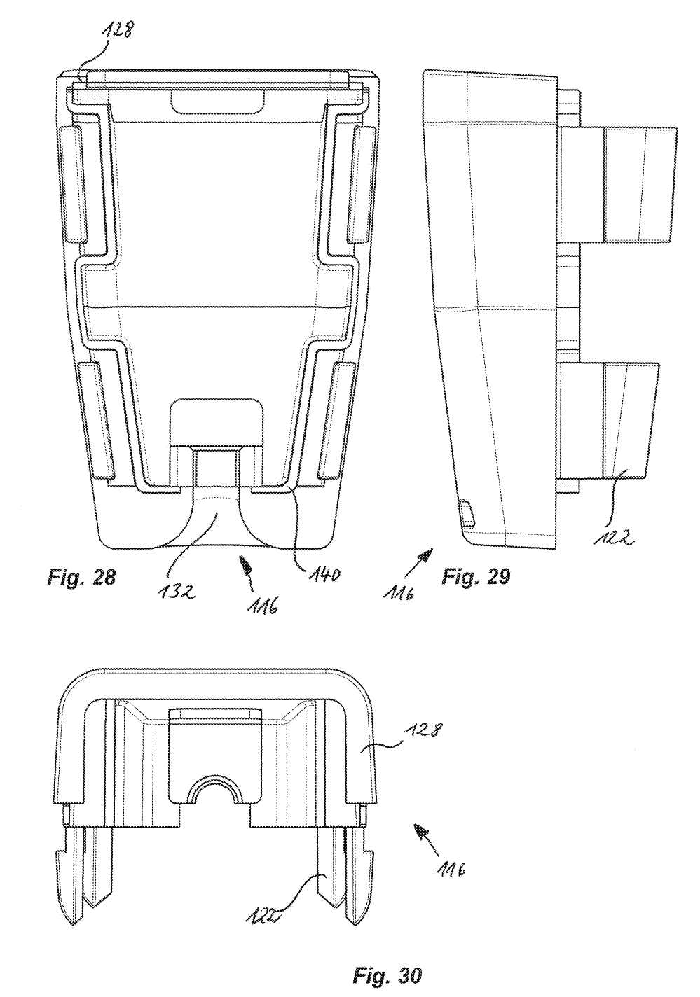

FIGS. 28 to 30 illustrate the second half shell 116. As can be seen from these Figures, the snap fit hooks 122 are formed to follow the outer contour of the first half shell 114, in order not to stick out from the smooth surface of the cover element 112.

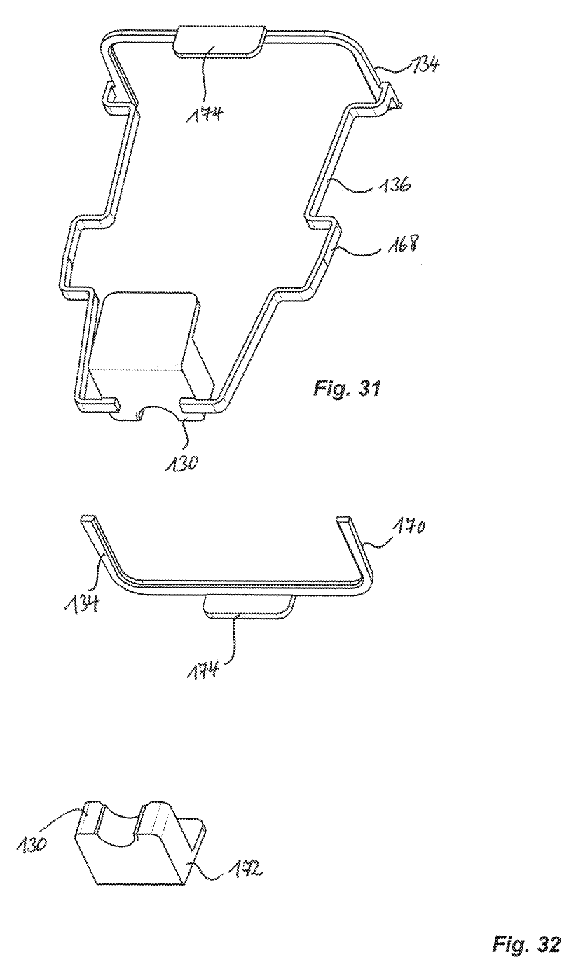

FIG. 31 illustrates a silicone gasket part 168 that is attached to the first half shell 114, while FIG. 32 illustrates two silicone gasket parts 170, 172 attached to the second half shell 116. As can be seen from these figures, each of the gasket parts has an anchoring pad 174 that fits into the indentations 164, 166, respectively.

According to the shown embodiment, the first half shell silicone gasket part 168 comprises half of the first sealing means 130 half of the second sealing means 134 and the third sealing means 136. The silicone gasket parts 170, 172 at the second half shell formed the other half of the second sealing means 134 and the first sealing means 130, respectively.

The silicone gasket parts 168, 170, 172 may either be provided as separate parts that are fabricated separately from the first and second half shell and are then fitted into the respective notch 162 and indentations 164, 166. Alternatively, the silicone gasket parts may also be fabricated integrally with the first and second half shell 114, 160 in a multi-stage casting process. Moreover, the distribution of the components of the sealing means into separate gasket parts may also the different from the arrangement shown in FIGS. 31 and 32.

In summary, the present invention provides a possibility of sealing a lead-through at the housing of an electrically functional component, for instance a power supply. Two parts of a protective cover are assembled together with the housing by means of a snap fit connection. The parts of the protective cover can be opened by releasing the snap fit connection. A soft material is provided at the parts of the protective cover for sealing. Moreover, the AC cable can be fixed by the protective cover during operation. Advantageously, the AC cable is exchangeable and is fixed and protected to prevent any incorrect operations.

REFERENCE NUMERALS

| Reference Numeral | Description |
|---|---|
| 100 | Housing |
| 102 | Electrical cable |
| 104 | Lead-through |
| 106 | Case body |
| 108 | Flange |
| 110 | Opening |
| 112 | Cover element |
| 114 | First half shell |
| 116 | Second half shell |
| 118 | Longitudinal axis |
| 120 | Joining region |
| 122 | Snap fit hook |
| 124 | Cut free bridge |
| 126 | Snap fit recess |
| 128 | Collar |
| 130 | First sealing means |
| 132 | Cable inlet |
| 134 | Second sealing means |
| 136 | Third sealing means |
| 138 | Plug connector |
| 140 | Sealing protrusion |
| 142 | Retention shoulder |
| 144 | Protrusion at the electrical cable |
| 146 | Pulling direction |
| 148 | Retention groove |
| 150 | Snap lock connection |
| 152 | Top element of the housing |
| 154 | Bottom element of the housing |
| 156 | Second lead-through |
| 158 | Snap fit protrusions |
| 160 | Snap fit recesses at housing |
| 162 | Notch |
| 164 | First indentation |
| 166 | Second indentation |
| 168 | Silicone gasket part at first half shell |
| 170, 172 | Silicone gasket parts at second half shell |
| 174 | Anchoring pad |

1. A cover element for protecting a lead-through of an electrical cable at a housing of an electronic component, said cover element comprising:
a first half shell,
a second half shell, wherein said second half shell is attached to the first half shell by means of at least one locking element, so that said cover element encompasses said electrical cable and said lead-through at least partly,
first sealing means for sealing an interface between the cover element and the cable, and second sealing means for sealing an interface between said cover element and the housing.

2. The cover element of claim 1, wherein said at least one locking element comprises at least one snap hook arranged at said first or second half shell and a corresponding snap fit recess for interacting with the snap hook, the snap fit recess being arranged on the opposing second or first half shell.

3. The cover element of claim 2, wherein said snap fit recess comprises a cut free bridge which interacts with the snap hook being formed by an outwardly oriented cantilever snap hook.

4. The cover element of claim 1, wherein said locking element is manually releasable.

5. The cover element of claim 1, further comprising third sealing means for sealing a contact interface between said first and said second half shell.

6. The cover element of claim 5, wherein at least one of the first to third sealing means comprises an elastic plastic material.

7. The cover element according to claim 1, wherein said cover element comprises a collar that extends inwardly toward a central longitudinal axis of the cover element, and is formed to engage with a mating groove at the housing for fixing the cover element at the housing.

8. The cover element of claim 1, wherein said cover element comprises retention means for providing a traction relief for the electrical cable.

9. The cover element of claim 1, wherein said cover element comprises a funnel shaped cable inlet, and wherein said first sealing means is arranged at an inner end of the funnel shaped cable inlet.

10. A waterproof housing arrangement for an electrical apparatus, the housing arrangement comprising a housing with at least one lead-through and a cover element according to claim 1.

11. The waterproof housing arrangement of claim 10, wherein the lead-trough is surrounded by an outwardly oriented flange forming said groove for engaging with said collar.

12. The waterproof housing arrangement of claim 11, wherein said second sealing means is arranged at a contact area between said outwardly oriented flange and said collar.

13. The waterproof housing arrangement of claim 10, wherein said first sealing means is in sealing contact with a cable jacket, exerting radial forces on the cable jacket, and wherein the first sealing means is further in sealing contact with a circumferential protrusion arranged at the cable for exerting axial pressure on the protrusion.

14. A waterproof power supply unit for supplying a consumer with low voltage, the waterproof supply unit comprising a housing arrangement according to claim 10, an electric converter circuit for converting mains voltage from a power source into a lower output voltage, and the electrical cable, wherein the electrical cable is connectable to said power source and/or wherein said electrical cable is connected to said electronic converter circuit via a releasable plug connection.

15. A method of assembling an electrical apparatus, the method comprising:
providing a housing with an electrically functional component accommodated therein, the housing having at least one lead-through for leading an electrical cable that is connected to the electrically functional component to the outside of the housing,
inserting said cable into the lead-through in an insertion direction along a longitudinal axis of said housing, and electrically connecting the electrical cable to said electrically functional component,
attaching a cover element, wherein the first half shell and the second half shell are assembled in an assembly direction perpendicular to said longitudinal axis and jointed to encompass said electrical cable.
